(19) United States
(12) Patent Application Publication
(10) Pub. No.: US 2025/0124204 A1
(43) Pub. Date: Apr. 17, 2025

(54) EFFICIENT METHOD FOR THE LATCH TIMING ANALYSIS OF ELECTRONIC DESIGNS

(71) Applicant: XILINX, INC., San Jose, CA (US)

(72) Inventors: Pawan KULSHRESHTHA, San Jose, CA (US); Atul SRINIVASAN, San Jose, CA (US)

(21) Appl. No.: 18/381,052

(22) Filed: Oct. 17, 2023

(51) Int. Cl. G06F 30/3312; G06F 30/31

(52) U.S. Cl. CPC G06F 30/3312; G06F 30/31

(57) ABSTRACT

Performing timing analysis of a circuit design includes building a timing graph of the circuit design, and determining delays of devices and wires of the circuit design based on the timing graph. Further, clock and arrival propagations for the circuit design are performed based on the delays of the devices and wires, latch loops are identified in the circuit design, and latch analysis on latches of the latch loops is performed. The timing analysis further includes performing arrival propagation for circuit elements of the circuit design impacted by the latch analysis performed on the latches of the latch loops, performing latch analysis on latches of the circuit design external to the latch loops, and performing required time and slack calculations on the circuit design.

### TECHNICAL FIELD

Examples of the present disclosure generally relate to a method for efficient timing analysis of circuits.

### BACKGROUND

Electronic design automation (EDA) are tools for creating integrated circuits (IC). In particular, EDA tools provide expeditious timing verification for timing sign-off and physical optimization. Timing analysis, which includes latch analysis, is a method of timing verification of a circuit design by checking all possible paths through the circuit for timing violations. Latch timing analysis involves iterations of data arrival propagation and latch timing computation until timing converges at all of the latches of a circuit design. It may take large number of iterations to converge timing through all of the latches of a circuit design. Therefore, there is exists a need for a method for latch analysis in a more efficient manner requiring less computational resources.

### SUMMARY

In one example, a method for performing timing analysis of a circuit design includes building a timing graph of the circuit design, and determining delays of devices and wires of the circuit design based on the timing graph. Further, the method includes performing clock and data arrival propagations for the circuit design based on the delays of the devices and wires, identifying latch loops in the circuit design, and performing latch analysis on latches of the latch loops. The method further includes performing data arrival propagation for circuit elements of the circuit design impacted by the latch analysis performed on the latches of the latch loops, performing latch analysis on latches of the circuit design external to the latch loops, and performing required time and slack calculations on the circuit design.

In one example, a processing system includes a memory storing instructions, and a processor coupled with the memory and configured to execute the instructions to cause the processor to build a timing graph of the circuit design and determine delays of devices and wires of the circuit design based on the timing graph. The processor is further caused to perform clock and data arrival propagations for the circuit design based on the delays of the devices and wires, to identify latch loops in the circuit design, and to perform latch analysis on latches of the latch loops. The processor is further caused to perform data arrival propagation for circuit elements of the circuit design impacted by the latch analysis performed on the latches of the latch loops, perform latch analysis on latches of the circuit design external to the latch loops, and perform required time and slack calculations on the circuit design.

In one example, a non-transitory computer readable medium comprising stored instructions, which when executed by a processor, cause the processor to build a timing graph of the circuit design, and determine delays of devices and wires of the circuit design based on the timing graph. Further, the processor is caused to perform clock and data arrival propagations for the circuit design based on the delays of the devices and wires, to identify latch loops in the circuit design, and to perform latch analysis on latches of the latch loops. The processor is further caused to perform data arrival propagation for circuit elements of the circuit design impacted by the latch analysis performed on the latches of the latch loops, to perform latch analysis on latches of the circuit design external to the latch loops, and to perform required time and slack calculations on the circuit design.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram illustrating an exemplary data processing system, according to one or more examples.

FIG. 2 is a schematic diagram of a circuit design according, to one or more examples.

FIG. 3 illustrates a method for timing analysis, according to one or more examples.

### DETAILED DESCRIPTION

Timing analysis for circuit designs, also known as static timing analysis, is a method for computing the expected propagation timing of signals within a circuit design without simulating the entire circuit. The output of the timing analysis can be used to verify whether a circuit design is meeting the timing requirements and indicate portions of the circuit design where the timing can be improved. Timing analysis involves identifying paths across the circuit design, determining the delay of each device along the path, determining data arrival times based on the delays and design constraints, determining required times based on delays and design constraints, and then comparing the data arrival time against required time to determine slack or a violation(s).

During timing analysis, the circuit design is mapped to a timing graph. A timing graph consists of nodes and edges where a node represents an input port, an output port, an input, or output pin of a device (combinational logic, register etc.), and an edge represents either a device connection or a wire connection between them and has an associated delay. The minimum and maximum delay of each edge is determined. The circuit design consists of clock paths and data paths. A clock path is a connection between a clock port and clock pin of a register (e.g., a flip-flop, a latch, or the like). The minimum and maximum clock arrival times at register clock pins and all nodes between clock ports and register clock pins are determined based on cumulative delays and design constraints along paths from clock port. A data path is a connection between an input port and a register (e.g., a flip-flop, a latch, or the like), a connection between two registers, a connection between a register and an output port, or a connection between an input port and an output port. The minimum and maximum data arrival times at end points and all nodes between start points and end points are determined. The start point may be defined as a register or an input port transmitting data, and the end point may be defined as a register or an output port receiving data. The minimum and maximum data arrival times at each node are determined based on, clock arrival times, cumulative delays, and design constraints along paths from start points to the node. For example, for register to register and register to output port paths, minimum and maximum arrival times at end point are determined based on clock arrival times at start point register clock pins, clock to output delays and cumulative delays of paths from register outputs. For input port to register and input port to output port paths, minimum and maximum arrival times at end point are determined based on input delay constraint on input ports and cumulative delay of paths from input ports.

In one or more examples, initially, clock signals are propagated to each register clock pin to determine clock arrival times. Next data arrival times are propagated from input ports and register clock pins to end points.

The latches differ from other registers such as the flip-flops because the latches have a transparent window in which they are active for the entire time. The transparent window occurs based on a clock signal, such as when a clock signal is high (or low). For example, a latch may be active for the entire time a clock pulse is high (or low), while a flip-flop is active for the rising (or falling) edge of the clock pulse. When data arrives after the start of a transparent window, the latch may borrow time from a subsequent path (stage). When a latch borrows time, the required time at latch data input improves and arrival time at latch data output worsens (i.e. increases). If the borrowing latch is part of a latch loop, this incremental change in the data arrival at latch data output propagates back to the borrowing latch data input once data arrivals are propagated through combinational logic and series of latches that make up the latch loop. This causes the borrowing latch to borrow more time in a next iteration. Time borrows at all latches and arrival propagation from all latch data outputs to end points are determined iteratively until timing converges at all latches. A latch timing converges when either latch input data arrival does not worsen further, or it has borrowed maximum time which is equal to clock transparent window minus setup time.

Problematically, it may take a large number of iterations to reach convergence if there are latch loops and the incremental change in borrowed time is very small compared to the transparent window. For example, in a field programmable gate array (FPGA), emulation designs running at slower frequencies, propagating these changes repeatedly through the entire design could be very expensive, increasing the processing and computational cost of timing analysis. Embodiments described herein identify and isolate the latch loops and determine data arrivals through the latch loops first significantly reducing the circuit through which data arrivals are propagated iteratively during large number of iterations resulting in improved performance for timing analysis and the computational cost of timing analysis. It then performs the remaining determinations/propagations for the reminder of the circuit design quickly in few iterations equal to the maximum number of cascaded latches which are not on loop.

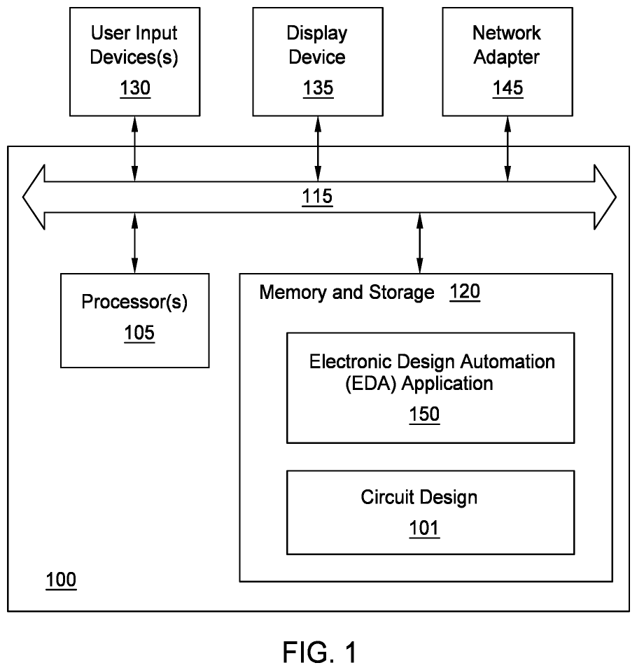

FIG. 1 is a block diagram illustrating an exemplary data processing system 100, according to one or more examples. The data processing system 100 is an example of a system configured to implement an electronic design automation (EDA) application 150. As pictured, the data processing system 100 includes at least one processor circuit (or “processor”), e.g., a central processing unit (CPU), 105 coupled to the memory and storage arrangement 120 through a system bus 115 or other suitable circuitry. The data processing system 100 stores program code and the circuit design 101 within the memory and storage arrangement 120. The processor 105 executes the program code accessed from the memory and storage arrangement 120 via system bus 115. In one example, the program code including instructions is executed by the processor 105 to perform the EDA application 150. In one aspect, the data processing system 100 is implemented as a computer or other the data processing system that is suitable for storing and/or executing program code. It should be appreciated, however, that the data processing system 100 can be implemented in the form of any system including a processor and memory that is capable of performing the functions described within this disclosure. The circuit design 101 includes any type of electronic circuitry and includes any type of electronic circuitry devices such as the flip-flops, the latches, combinational logic devices, or the like.

The memory and storage arrangement 120 includes one or more physical memory devices such as, for example, a local memory (not shown) and a persistent storage device (not shown). Local memory refers to random access memory or other non-persistent memory device(s) generally used during actual execution of the program code. Persistent storage can be implemented as a hard disk drive (HDD), a solid-state drive (SSD), or other persistent data storage device. The data processing system 100 may also include one or more cache memories (not shown) that provide temporary storage of at least some program code and data in order to reduce the number of times program code and data must be retrieved from local the memory and persistent storage during execution.

Input/output (I/O) devices such as user input device(s) 130 and a display device 135 may be optionally coupled to the data processing system 100. The I/O devices may be coupled to the data processing system 100 either directly or through intervening I/O controllers. A network adapter 145 also can be coupled to the data processing system 100 in order to couple the data processing system 100 to other systems, computer systems, remote printers, and/or remote storage devices through intervening private or public networks. Modems, cable modems, Ethernet cards, and wireless transceivers are examples of different types of network adapter 145 that can be used with the data processing system 100.

The memory and storage arrangement 120 may store an EDA application 150. The EDA application 150, being implemented in the form of executable program code, is executed by processor(s) 105. As such, the EDA application 150 is considered part of the data processing system 100. The data processing system 100, while executing the EDA application 150, receives and operates on the circuit design 101. In one aspect, the data processing system 100 performs a timing analysis on the circuit design 101, as described in more detail below. Based on the timing analysis, the circuit design 101 may be updated by the EDA application 150. This will be described in more detail below.

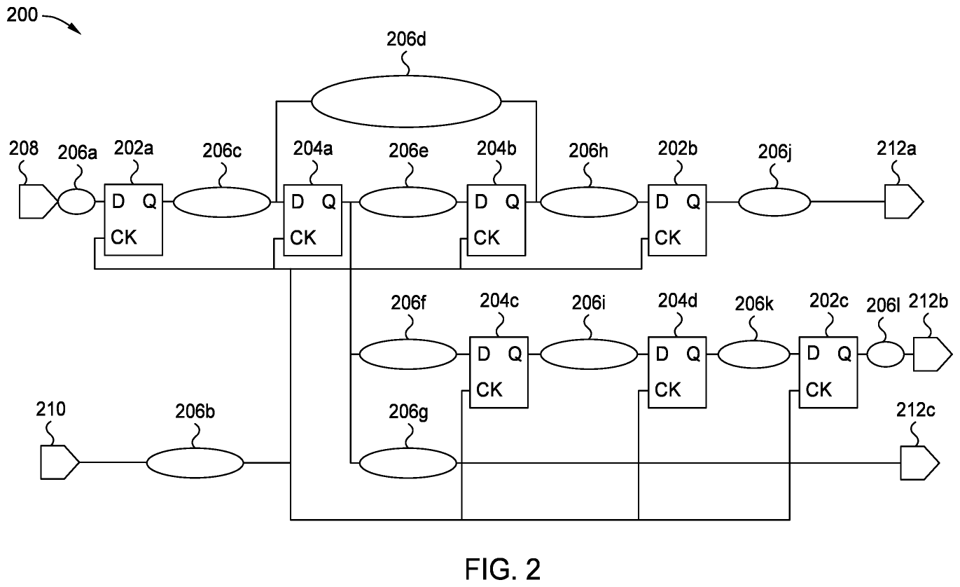

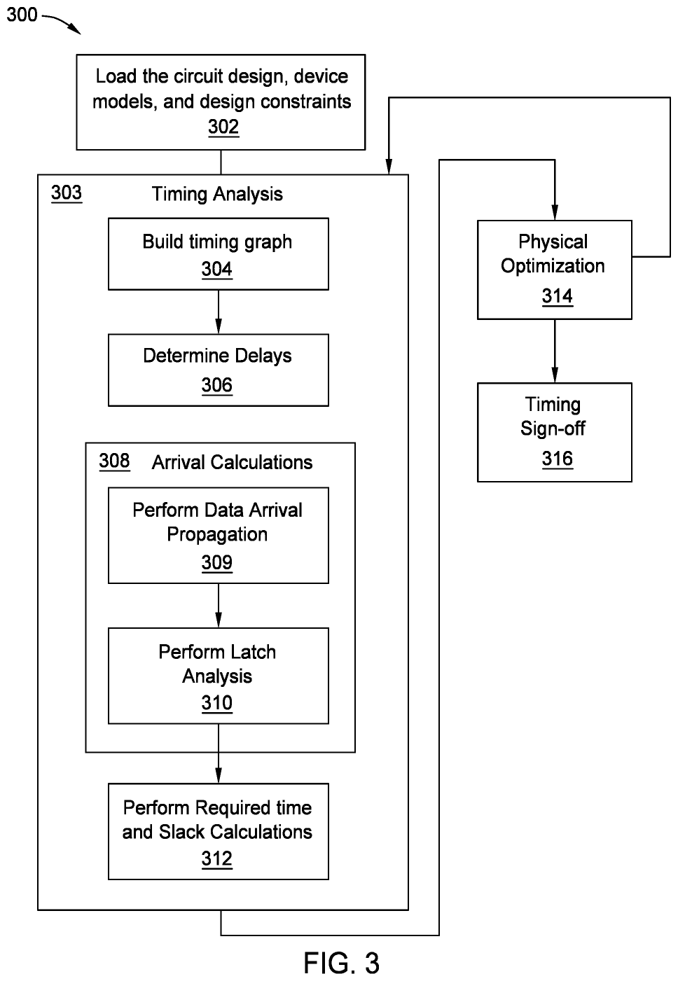

FIG. 2 is a schematic diagram of a circuit design 200, according to one or more examples. FIG. 3 illustrates a flowchart of a method 300 for timing analysis according to one or more examples.

In one example, the circuit design 200 is stored in the memory and storage arrangement 120 of the data processing system 100 (FIG. 1). The circuit design 200 includes an input port, a clock port, output ports, registers, and combinational logic circuitries. In one example, the circuit design 200 includes flip-flops 202a-202c, the latches 204a-204d, combinational logic circuitries 206a-206l, input port 208, clock port 210, and output ports 212a-212c. A register includes, but is not limited to, the latches and the flip-flops. For example, the flip-flops 202a-202c and the latches 204a-204d are considered registers. Each of the combinational logic circuitries 206a-206l are disposed between an input port (e.g., input port 208) and a register, a register and another register, a clock port (e.g., clock port 210) and a register, and a register and an output port (e.g., output ports 212a-212c).

Each of the flip-flops 202a-202c and each of the latches 204a-204d (i.e., each register) includes input pins (D-pins) that receive data, output pins (Q-pins) that transmit data, and clock pins (CK pins) that receive a clock signal from the clock port 210 (i.e., the output from a clock source). Although the circuit design 200 only includes two types of registers, this is for example purposes only, and other types of registers may be included in the circuit design 200.

Each of the combinational logic circuitries 206a-206l includes a plurality of individual combinational logic circuitries. For example, each of the combinational logic circuitries 206a-206l may include hundreds, thousands, millions, or even more individual combinational logic circuitries.

In one example, the input port 208 is coupled to the input of the combinational logic circuitry 206a. The output of the combinational logic circuitry 206a is coupled to the input of the flip-flop 202a. The output of the flip-flop 202a is coupled to the combinational logic circuitry 206c. The output of the combinational logic circuitry 206c is coupled to the latch 204a. The output of the latch 204a is coupled to the input of the combinational logic circuitry 206e. The output of the combinational logic circuitry 206e is coupled to the input of the latch 204b. The output of the latch 204b is coupled to the input of the combinational logic circuitry 206d and the combinational logic circuitry 206h. The output of the combinational logic circuitry 206d is coupled to the input of the latch 204a. Thus forming a latch loop including the latch 204a, the combinational logic circuitry 206e, the latch 204b, and the combinational logic circuitry 206d.

The output of the latch 204b is also coupled to the input of the combinational logic circuitry 206h. The output of the combinational logic circuitry 206h is coupled to the input of the flip-flop 202b. The output of the flip-flop 202b is coupled to the input of the combinational logic circuitry 206j. The output of the combinational logic circuitry 206j is coupled to output port 212a.

Additionally, the input of the combinational logic circuitry 206f and the input of the combinational logic circuitry 206g are coupled to the output of the latch 204a. The output of the combinational logic circuitry 206g is coupled to output port 212c. The output of the combinational logic circuitry 206f is coupled to the latch 204c. The output of the latch 204c is coupled the input of the combinational logic circuitry 206i. The output of the combinational logic circuitry 206i is coupled to the latch 204d. The output of the latch 204d is coupled to the input of the combinational logic circuitry 206k. The output of the combinational logic circuitry 206k is coupled to the input of the flip-flop 202c. The output of the flip-flop 202c is coupled to the input of the combinational logic circuitry 206l. The output of the combinational logic circuitry 206l is coupled to output port 212b.

The output of the clock port 210 is coupled to the input of the combinational logic circuitry 206b. The output of the combinational logic circuitry 206b is coupled to clock pins (CK pins) of each of the flip-flops 202a-202c, and each of the latches 204a-204d.

At block 302 of the method 300, the circuit design, device models, and design constraints are loaded. For example, the processor(s) 105 obtain the circuit design 200 from the memory and storage 120. Further, the processor(s) obtain device models and design constraints. The device models correspond to the circuit elements of the circuit design 101. The device models include functional and delay information for the device. The design constraints include timing constraints, power constraints, and/or area constraints for the circuit design 101.

At block 303 of the method 300, timing analysis is performed by the data processing system 100 by executing program code associated with the EDA application 150 with the processor(s) 105. In one example timing analysis includes blocks 304-312.

At block 304 of the method 300, a timing graph is built. In one example, the timing graph is generated by the data processing system 100 using the EDA application 150. The timing graph is built based on the circuit design 200 stored in the memory and storage arrangement 120 of the data processing system 100. As noted above, the timing graph includes nodes and edges. Nodes are used to represent input ports, output ports, input and output pins of each circuit element of the circuit design 200. For example, a node is used to represent input port 208, the D-pin of the flip-flop 202a, the CK pin of the flip-flop 202a, the Q-pin of the flip-flop 202a. Nodes are also used to represent inputs and outputs of devices included in each of the combinational logic circuitries 206a-206i. Nodes are coupled by edges. Each edge between two nodes represents either the wire connection or the device connection and has an associated delay.

At block 306 of the method 300, delays of each device and wire of the circuit design 200 are determined. In one example, the delays are calculated by the data processing system 100 using the EDA application 150. In one example, the minimum and maximum delays of devices and wires are determined as described in the following.

In one or more example, delays are determined for each edge of the timing graph. Stated differently, a minimum and maximum delay associated with each edge is determined based on timing graph and device models. The delays that are determined include, but are not limited to, delays that are internal to the circuit elements, wire delays, or the like. As an example, minimum and maximum delays of each of the combinational logic devices in the combinational logic circuitry 206a are determined.

At block 308 of the method 300 arrival calculations are performed. In one example, the arrival calculations are performed by the data processing system 100 using the EDA application 150. In one example performing arrival calculations includes blocks 309-310. As understood by those with ordinary skill in the art, arrivals are defined herein as the time at which a data signal arrives at an input pin or an output pin.

At block 309 of the method 300 arrival propagation is performed. In one example, the arrival propagation is performed by the data processing system 100 using the EDA application 150.

In one example, initially, clock signals are propagated to each node representing a CK pin of each register of circuit design 200 and the minimum and maximum clock arrivals are determined. When two or more edges merge on a node, minimum (or maximum) clock arrivals on the node are determined by taking the minimum (or maximum) of clock arrivals from all edges. As understood by those with ordinary skill in the art, clock arrivals, as defined herein, refer to a time a clock signal reaches a clock pin.

In one or more examples, minimum and maximum clock arrivals are determined and propagated at every node between clock port and nodes representing clock (CK) pins of each register of circuit design 200. For example, minimum and maximum clock arrivals are propagated from the node representing clock port 210 through each of the nodes representing the combinational logic circuitry 206b to the nodes representing CK pins of flip-flops 202a-202c and the latches 204a-204c (i.e., each clock path). Although each node representing a CK pin is coupled to a single clock port 210 through a single combinational logic circuitry, this is for example purposes only. It is understood that different clock ports corresponding to different clock signal can be coupled to different nodes representing CK pins and through different combinational logic circuitries.

The clock arrivals at each node are determined based on timing constraints and cumulative delays of edges along clock paths to the node. In one example, the minimum and maximum clock arrivals for each node representing a CK pin of each register are determined. For example, the maximum clock arrival at the node representing the CK pin of flip-flop 202a is determined based on the maximum clock timing constraint, and the maximum delays associated with each edge in the fan-in cone of the node representing the CK pin of flip-flop 202a. On the other hand, the minimum clock arrival at the node representing the CK pin of flip-flop 202a is determined based on the minimum clock timing constraint, and the minimum delays associated with each edge on the fan-in cone of the node representing the CK pin of flip-flop 202a. A fan-in cone of a node includes any edge that is directly or indirectly coupled to said node.

The minimum and maximum arrivals are determined and propagated at every node between start points and end points. When two or more edges merge on a node, minimum (or maximum) data arrivals on the node are determined by taking the minimum (or maximum) of data arrivals from all edges.

The minimum and maximum arrivals on end points of the circuit design 200 are determined based on, clock arrivals, timing constraints and cumulative delays along paths from nodes representing start points to nodes representing end points. For example, arrivals are determined for each node representing input pins (D-pins) of flip-flops 202a-202c, the latches 204a-204b, and output ports 212a-212c.

In one example, the cumulative delay includes each of the minimum and maximum edge delays accumulated along a data path. For example, the maximum arrival at the node representing the D-pin of flip-flop 202a is determined based on the maximum timing constraints of a node representing the start point (e.g., the maximum input delay of input port 208), and the cumulative delays (i.e., the sum of each of the maximum delays) along the data paths from the node representing input port 208 and the node representing the D-pin of flip-flop 202a. The minimum arrival at the node representing the D-pin of flip-flop 202a is determined based on the minimum timing constraints (e.g., the minimum input delay of input port 208), and the cumulative delays (i.e., the sum of each of the minimum delays) along the data paths from the node representing input port 208 and the node representing the D-pin of flip-flop 202a.

At block 310 of method 300, the latch analysis is performed. In one example, using the timing graph, each latch loop in the circuit design 200 is identified. In one example, the EDA application 150 traverses fan-in cones of all latch data input nodes in depth-first manner going through latch data input to data output edges. When a loop found, it is broken at that edge and all traversed nodes in the fan-out cone of such an edge are labeled using a first tag. Next, the EDA application 150 traverses fan-out cones of all latch data output nodes in depth-first manner going through latch data input to data output edges. When a loop found, it is broken at that edge and all traversed nodes in the fan-in cone of such an edge are labeled using a second tag. The EDA application 150 determines that the nodes that are marked with the first tag and the second tag are the nodes that are included in a latch loop.

With reference to the circuit design 200 of FIG. 2, the fan-in cones of the latch data input nodes of latches 204a, 204b, 204c and 204d are traversed in that order in a depth-first manner going through the latch data input to data output edges. In other examples, the latches 204a, 204b, 204c and 204d may be traversed in any other order. When the latch 204a data input node is traversed, a loop is found and broken at the latch 204a data input to data output edge (D to Q), and all data input and data output nodes of the latch 204a, the combinational logic circuitry 206d, the latch 204b, and the combinational logic circuitry 206e are labeled using first tag. Since, the latch 204b data input is already traversed, it is not traversed again. When the latch 204c data input node is traversed, it finds a node already labeled using first tag and its data input node and all data input and data output nodes of the combinational logic circuitry 206f are labeled using first tag. Similarly, when the latch 204d data input node is traversed, it finds a node already labeled using first tag and its data input node, the latch 204c data output node and all data input and data output nodes of the combinational logic circuitry 206i are labeled using first tag. Next, the fan-out cones of the latch data output nodes of the latches 204a, 204b, 204c and 204d are traversed in that order in a depth-first manner going through the latch data input to data output edges. In other examples, the latches 204a, 204b, 204c and 204d may be traversed in any other order. When the latch 204a data output node is traversed, a loop is found and broken at the latch 204a data input to data output edge (D to Q), and all data input and data output nodes of the latch 204a, the combinational logic circuitry 206d, the latch 204b, and the combinational logic circuitry 206e are labeled using second tag. Since, the latch 204b output data node is already traversed, it is not traversed again. When the latch 204c and the latch 204d data output nodes are traversed, no loop or a node with second tag is found. Finally, all data input and data output nodes of the latch 204a, the combinational logic circuitry 206d, the latch 204b and the combinational logic circuitry 206e which are labeled using first tag and second tag, are labeled as nodes on a latch loop. While in the above example, a loop is described as being broken at an edge associated with a latch, in other examples, a loop can be broken at other edges.

The circuit design 200 includes one latch loop that follows a data path as follows: the latch 204a, the combinational logic circuitry 206e, the latch 204b, the combinational logic circuitry 206d, and back to the latch 204a. Although circuit design 200 includes one latch loop, it is understood a circuit design can include any quantity of the latch loops.

Once nodes of circuit design consisting of latch loops are marked, iterations of latch timing calculation and maximum data arrival propagation are performed on latches on loops. During this stage minimum data arrival propagation is disabled as latch timing computation depends on maximum data arrival only.

During latch timing computation, the amount of borrowed time on each latch on a loop is determined and the data arrivals on the Q-pin of each the latch are updated based on the amount of borrowed time. As noted above, if the maximum arrival on a D-pin of a latch occurs during or after latch transparent window, then the D-pin of the latch borrows time from the Q-pin and the Q-pin data arrival worsens. Stated differently, if the maximum arrival on a node representing a D-pin of a latch occurs during or after latch transparent window, the maximum arrival on the node representing the Q-pin of the latch increases. For example, if the maximum arrival on a node representing a D-pin of the latch 204a occurs during or after latch 204a transparent window, the maximum arrival on a node representing the Q-pin of the latch 204a increases (i.e. worsens). The increase is equal to the borrowed time. Borrowed time is equal to the amount by which data arrivals overlap latch transparent window. Maximum amount a latch can borrow is limited to latch transparent window minus setup time.

Then, the updated maximum arrivals on the Q-pins of each latch on loops are propagated in its fan-out cone. For example, the updated maximum arrival of the node representing the Q-pin of the latch 204a is transmitted to the D-pin of the latch 204b through edges and nodes that represent the combinational logic circuitry 206e. Likewise, the updated maximum arrival of the node representing the Q-pin of the latch 204b is transmitted to the D-pin of the latch 204a through edges and nodes that represent the combinational logic circuitry 206d. Based on the maximum updated arrivals on the Q-pins of the latches 204a-204b, the maximum arrivals on the nodes representing the D-pins of the latches 204a-204b are updated. This process is repeated until timing at both the latches 204a-204b converge. As noted above, latch timing converges when either data arrival at D pin does not worsen further, or the latch has borrowed maximum time which is equal to clock transparent window minus setup time.

Next, in one example, minimum data arrival propagation is enabled, and the minimum and maximum arrivals are re-determined for the impacted circuit design based on the above latch analysis. In one example with reference to FIG. 2 and the above example, the impacted elements of the circuit design include the latches 204a, 204b, the D pin of latch 204c, combinational logic circuitries 206d, 206e, 206f, and 206g. The minimum and maximum arrivals are re-determined using the steps described above.

Latch analysis is performed on each of the remaining latches outside of the latch loop. Here, because the remainder of the circuit design 200 includes two latches (the latches 204c and 204d) outside of the latch loop, only two iterations are required before timing converges through the latches 204c and 204d. Advantageously, by performing the latch timing analysis through the latch loop first, arrivals are not propagated through combinational logic circuitries 206f, 206g and 206 and to the latches 204c and 204d, significantly reducing the circuit through which arrivals are propagated iteratively during a large number of iterations, resulting in improved performance for timing analysis, and the computational cost of timing analysis. Additionally, by only determining the maximum arrivals during the latch analysis of the latch loop, the number of calculations required for the latch timing analysis of the latch loop is decreased.

At block 312 of method 300, the required time and slack calculations are performed. In one example, the required time and slack calculations are calculated by the data processing system 100 using the EDA application 150. The minimum and maximum required times are determined and propagated from end points to start points. The minimum and maximum arrival times are compared to respective required times to determine setup (maximum) or hold (minimum) slack (or violation). A setup slack is a difference between maximum required time and maximum arrival time. A hold slack is a difference between minimum arrival time and minimum required time. A negative slack indicates a timing violation while a positive slack indicates available margin.

At block 314 of the method 300, the circuit design 200 is physically updated based on the timing analysis. In one example, the circuit design 200 is physically updated by the data processing system 100 using the EDA application 150. The updated circuit is saved in the memory and storage arrangement 120. In another example, the circuit design 200 is updated manually. In one example, the EDA application loops back through timing analysis (block 303) until there are zero timing violations or the EDA application determines that it cannot further improve the timing of the circuit design 200. Once the EDA application 150 determines physical optimization no longer need to be performed, the method 300 proceeds to block 318.

At block 318 of the method 300 timing sign-off is performed to verify that the design meets timing requirements. In one example, timing sign-off involves generating a report of the results of the timing analysis using the data processing system 100 via the EDA application 150. In some examples, based on the report, the circuit design is manually updated.

While the foregoing is directed to specific examples, other and further examples may be devised without departing from the basic scope thereof, and the scope thereof is determined by the claims that follow.

1. A method for performing timing analysis of a circuit design, the method comprising:
building a timing graph of the circuit design;
determining delays of devices and wires of the circuit design based on the timing graph;
performing clock and arrival propagations for the circuit design based on the delays of the devices and wires;
identifying latch loops in the circuit design;
performing latch analysis on latches of the latch loops;
performing arrival propagation for circuit elements of the circuit design impacted by the latch analysis performed on the latches of the latch loops;
performing latch analysis on latches of the circuit design external to the latch loops; and
performing required time and slack calculations on the circuit design.

2. The method of claim 1, wherein identifying the latch loops comprises traversing fan-in cones of latch data input nodes of the timing graph in a depth-first manner going through latch data input to data output edges of the timing graph, wherein when a first loop is found, the first loop is broken at a most recently traversed edge of the first loop, and traversed nodes in a fan-out cone of the most recently traversed edge of the first loop are labeled using a first tag, and wherein the most recently traversed edge of the first loop is reset after nodes associated with the first loop are labeled.

3. The method of claim 2, wherein identifying the latch loops further comprises traversing fan-out cones of latch data output nodes of the timing graph in a depth-first manner going through the latch data input to data output edges of the timing graph, wherein when a second loop is found, the second loop is broken at a most recently traversed edge of the second loop and traversed nodes in a fan-in cone of the most recently traversed edge of the second loop are labeled using a second tag, and wherein the most recently traversed edge of the second loop is reset after nodes associated with the second loop are labeled.

4. The method of claim 3, wherein identifying the latch loops further comprises labeling the nodes labeled with the first tag and the second tag as nodes of the latch loops.

5. The method of claim 1, wherein performing the latch analysis on the latches of the latch loops comprises performing iterations of latch timing calculations and propagating data arrivals across the circuit design associated with the latch loops until latch timing converges for the latches of the latch loops.

6. The method of claim 5, wherein performing the latch analysis on the latches of the latch loops comprises performing maximum data arrival propagation on the latch loops, and wherein minimum data arrival propagation is disabled when performing the latch analysis on the latches of the latch loops.

7. The method of claim 5, wherein the latch timing converges for a latch when arrival at an input data pin of the latch does not worsen or a maximum amount of time has been borrowed for the latch.

8. The method of claim 1, wherein performing the arrival propagation for the impacted circuit elements comprises performing maximum data arrival propagation and minimum data arrival propagation on the impacted circuit elements of the circuit design based on the latch analysis on the latches of the latch loops.

9. The method of claim 8, wherein performing latch analysis on the latches of the circuit design external to the latch loops comprises performing iterations of latch timing calculations and propagating data arrivals across the latches external to the latch loops based on the latch analysis performed on the latch loops and subsequent arrival propagation until timing converges for the latches external to the latch loops.

10. A processing system comprising:
a memory storing instructions; and
a processor coupled with the memory and configured to execute the instructions to cause the processor to:
build a timing graph of a circuit design;
determine delays of devices and wires of the circuit design based on the timing graph;
perform clock and arrival propagations for the circuit design based on the delays of the devices and wires;
identify latch loops in the circuit design;
perform latch analysis on latches of the latch loops;
perform arrival propagation for circuit elements of the circuit design impacted by the latch analysis performed on the latches of the latch loops;
perform latch analysis on latches of the circuit design external to the latch loops; and
perform required time and slack calculations on the circuit design.

11. The processing system of claim 10, wherein identifying the latch loops comprises traversing fan-in cones of latch data input nodes of the timing graph in a depth-first manner going through latch data input to data output edges of the timing graph, wherein when a first loop is found, the first loop is broken at a most recently traversed edge of the first loop, and traversed nodes in a fan-out cone of the most recently traversed edge of the first loop are labeled using a first tag, and wherein the most recently traversed edge of the first loop is reset after nodes associated with the first loop are labeled.

12. The processing system of claim 11, wherein identifying the latch loops further comprises traversing fan-out cones of latch data output nodes of the timing graph in a depth-first manner going through the latch data input to data output edges of the timing graph, wherein when a second loop is found, the second loop is broken at a most recently traversed edge of the second loop and traversed nodes in a fan-in cone of the most recently traversed edge of the second loop are labeled using a second tag, and wherein the most recently traversed edge of the second loop is reset after nodes associated with the second loop are labeled.

13. The processing system of claim 12, wherein identifying the latch loops further comprises labeling the nodes labeled with the first tag and the second tag as nodes of the latch loops.

14. The processing system of claim 10, wherein performing the latch analysis on the latches of the latch loops comprises performing iterations of latch timing calculations and propagating data arrivals across the circuit design associated with the latch loops until latch timing converges for the latches of the latch loops.

15. The processing system of claim 14, wherein performing the latch analysis on the latches of the latch loops comprises performing maximum data arrival propagation on the latch loops, and wherein minimum data arrival propagation is disabled when performing the latch analysis on the latches of the latch loops.

16. The processing system of claim 14, wherein the latch timing converges for a latch when arrival at an input data pin of the latch does not worsen or a maximum amount of time has been barrowed for the latch.

17. The processing system of claim 10, wherein performing the arrival propagation for the impacted circuit elements comprises performing maximum data arrival propagation and minimum data arrival propagation on the impacted circuit elements of the circuit design based on the latch analysis on the latches of the latch loops.

18. The processing system of claim 17, wherein performing latch analysis on the latches of the circuit design external to the latch loops comprises performing iterations of latch timing calculations and propagating data arrivals across the latches external to the latch loops based on the latch analysis performed on the latch loops and subsequent arrival propagation until timing converges for the latches external to the latch loops.

19. A non-transitory computer readable medium comprising stored instructions, which when executed by a processor, cause the processor to:
build a timing graph of a circuit design;
determine delays of devices and wires of the circuit design based on the timing graph;
perform clock and arrival propagations for the circuit design based on the delays of the devices and wires;
identify latch loops in the circuit design;
perform latch analysis on latches of the latch loops;
perform arrival propagation for circuit elements of the circuit design impacted by the latch analysis performed on the latches of the latch loops;
perform latch analysis on latches of the circuit design external to the latch loops; and
perform required time and slack calculations on the circuit design.

20. The non-transitory computer readable medium of claim 19, wherein identifying the latch loops comprises at least one of:
traversing fan-in cones of latch data input nodes of the timing graph in a depth-first manner going through latch data input to data output edges of the timing graph, wherein when a first loop is found, the first loop is broken at a most recently traversed edge of the first loop, and traversed nodes in a fan-out cone of the most recently traversed edge of the first loop are labeled using a first tag, and wherein the most recently traversed edge of the first loop is reset after nodes associated with the first loop are labeled, and
wherein identifying the latch loops further comprises traversing fan-out cones of latch data output nodes of the timing graph in a depth-first manner going through the latch data input to data output edges of the timing graph, wherein when a second loop is found, the second loop is broken at a most recently traversed edge of the second loop and traversed nodes in a fan-in cone of the most recently traversed edge of the second loop are labeled using a second tag, and wherein the most recently traversed edge of the second loop is reset after nodes associated with the second loop are labeled.
